(19) United States
(12) Patent Application Publication
(10) Pub. No.: US 2005/0125808 A1
(43) Pub. Date: Jun. 9, 2005

(54) Object-oriented callback systems and methods

(76) Inventor: Clemente Ignacio Izurieta, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/731,395

(22) Filed: Dec. 9, 2003

(51) Int. Cl. G06F 9/46

(52) U.S. Cl. 719/318

(57) ABSTRACT

An object-oriented method and callback system are disclosed. One embodiment of the system, among others, includes a client class that is configured receive information corresponding to an event in an artwork of a microchip design. The client class is configured to use the information to report on the event.

### CROSS-REFERENCE TO RELATED APPLICATION

This application is related to copending U.S. utility patent application entitled “Semi-Greedy Scan and Detection Systems and Methods” filed on ______/2003, and accorded Ser. No. ______, which is entirely incorporated herein by reference.

### BACKGROUND

Electronic design applications (EDA) tools report such events as overlap, touches, etc. when scan traversing physical layouts, or artwork, of microchip designs. Conventional reporting methods include using callback mechanisms whereby a pointer to a function is registered. A traversal engine or server can use the pointer to report the given event. For example, a client application basically implements a function and passes its pointer to the traversal engine. The traversal engine, in turn calls this function whenever it encounters an overlap of two shape objects. The client application then decides whether the event is indeed an overlap, or a simple touch. Such reporting mechanisms have several drawbacks, including lack of extensibility and a dependence on the traversal engine.

### SUMMARY

One embodiment of invention may comprise an object-oriented method for a client application, comprising registering for events occurring during an analysis of a physical layout of a microchip design, including creating a class to implement a method that is responsive to an event, and registering the event with a server class, wherein the registering includes providing a pointer to the class.

Another embodiment may comprise an object-oriented method for a server class, comprising registering for events occurring during an analysis of a physical layout of a microchip design, including receiving a request from a class to store an event, and storing the event in a table.

Another embodiment may comprise an object-oriented method for a client application, comprising implementing a callback in response to an event in a physical layout of a microchip design, including receiving a call from a server class to implement a callback, receiving information corresponding to an event in the call, and executing the callback in a receiver class that is decoupled from the server class.

Another embodiment may comprise an object-oriented method for a server engine class, comprising initiating a callback in response to an event occurring in a physical layout of a microchip design, including receiving an indication of the event, and searching a table for an event identifier corresponding to the event and a pointer to an instantiated server class that will make a call to a responsible receiver class.

Another embodiment may comprise an object-oriented callback system, comprising a client class configured to receive information corresponding to an event in an artwork of a microchip design, said client class configured to use the information to report on the event.

Another embodiment may comprise an object-oriented callback system, comprising means for creating a class to implement a method that is responsive to an event, means for detecting the event in artwork of a microchip design, means for passing information about the type of event and information about objects that caused the event to occur, and means for reporting the event.

Another embodiment may comprise a computer readable medium having a computer program comprising an object-oriented method for a client application, comprising logic configured to register for events occurring during an analysis of a physical layout of a microchip design, including logic configured to create a class to implement a method that is responsive to an event, and logic configured to register the event with a server class, wherein the registering includes providing a pointer to the class.

Another embodiment may comprise a computer readable medium having a computer program comprising an object-oriented method for a server class, comprising logic configured to register for events occurring during an analysis of a physical layout of a microchip design, including logic configured to receive a request from a class to store an event, and logic configured to store the event in a table.

Another embodiment may comprise a computer readable medium having a computer program comprising an object-oriented method for a client application, comprising logic configured to implement a callback in response to an event in a physical layout of a microchip design, including logic configured to receive a call from a server class to implement a callback, logic configured to receive information corresponding to an event in the call, and logic configured to execute the callback in a receiver class that is decoupled from the server class.

Another embodiment may comprise a computer readable medium having a computer program comprising an object-oriented method for a server class, comprising logic configured to initiate a callback in response to an event occurring in a physical layout of a microchip design, including logic configured to receive an indication of the event, and logic configured to search a table for an event identifier corresponding to the event and a pointer to an instantiated server class that will make a call to a responsible receiver class.

### BRIEF DESCRIPTION OF THE DRAWINGS

The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of an example implementation for an embodiment of an object-oriented callback system.

FIG. 2A is a block diagram of an embodiment of the object-oriented callback system shown in FIG. 1.

FIG. 2B is a block diagram of an another embodiment of the object-oriented callback system shown in FIG. 1.

FIG. 3 is a schematic diagram used to illustrate an embodiment of the object-oriented callback system shown in FIGS. 2A and 2B in cooperation with an example physical layout scan traversal system.

FIG. 4A is a block diagram used to illustrate the cooperation of modules of the object-oriented callback system shown in FIG. 3 in response to a detected event.

FIG. 4B is a flow diagram that illustrates one embodiment of an example method employed by the object-oriented callback system of FIG. 3 from a client application perspective.

FIG. 4C is a flow diagram that illustrates one embodiment of an example method employed by the object-oriented callback system of FIG. 3 from a server perspective.

FIGS. 5A-5B are programming diagrams of example client application pseudo code of the object-oriented callback system of FIG. 3.

FIGS. 6A-6H are programming diagrams of example server pseudo code of the object-oriented callback system of FIG. 3.

FIG. 7 is a flow diagram that illustrates one embodiment of an example object-oriented method employed by the object-oriented callback system of FIG. 3 for a client application.

FIG. 8 is a flow diagram that illustrates one embodiment of an example object-oriented method employed by the object-oriented callback system of FIG. 3 for a server class.

FIG. 9 is a flow diagram that illustrates one embodiment of an example object-oriented method employed by the object-oriented callback system of FIG. 3 for a client application.

FIG. 10 is a flow diagram that illustrates one embodiment of an example object-oriented method employed by the object-oriented callback system of FIG. 3 for a server engine class.

### DETAILED DESCRIPTION

Disclosed herein are various embodiments of an object-oriented callback system and method, or for convenience, object-oriented callback system. The object-oriented callback system may include functionality that provides for reporting of events in scan-based traversals of microchip physical layout, or artwork, data. As the traversal occurs, the object-oriented callback system may provide a client application(s) (e.g., client to the software of described embodiments) with information pertaining to the cause of a given event. The object-oriented callback system may use extensible object-oriented methods. From a server or scan traversal engine perspective, extensibility may be facilitated since a new class can be created to handle each new event, taking full advantage of polymorphism. From a client application perspective, extensibility may be facilitated since a new application programming interface (API), or method, can be added to handle each new callback without having to change a class schema. APIs and methods will herein be used interchangeably, as APIs are a generic term generally used to describe “public” methods available to clients of software, as would be understood by one having ordinary skill in the art.

In some embodiments, there also exists full-encapsulation of the callback mechanisms. In other words, a user need not be concerned about the implementation details of the callback mechanisms of the object-oriented callback system, since the mechanisms can be hidden and accessed via public APIs. This feature facilitates the implementation of the object-oriented callback system as separate modules according to at least one embodiment of the invention. Further, the object-oriented callback system may enable the decoupling of the callback mechanisms from the scan traversal engine performing the physical layout traversals. Further, there is no need to re-compile the client application if the server is upgraded to report new events. The client application can define its own substructure to handle events.

The object-oriented callback system may, in some embodiments, also provide an information-laden API to client applications. For example, the object-oriented callback system may implement an API for registration and/or unregistration of a plurality of different events. Passed parameters include the information about the objects causing the events, enabling a client application to receive “rich” data that can be processed further (e.g., creation of statistics, undo complex operations, etc.). Additionally, because each callback is an instantiation of an object, information corresponding to the object can be stored (e.g., serialized) for later use.

Certain embodiments of an object-oriented callback system will herein be discussed in the context of VLSI CAD (very large scale integration, computer-aided design) tools used to report on events, such as overlaps between objects (e.g., circuits, interconnections, etc.), object touches, etc., with the understanding that other event-reporting is considered to be within the scope of the invention.

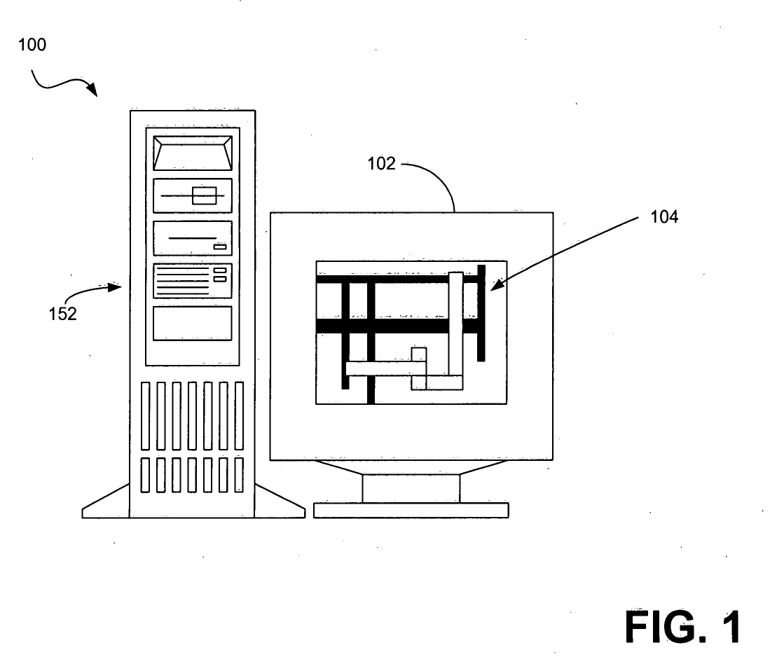

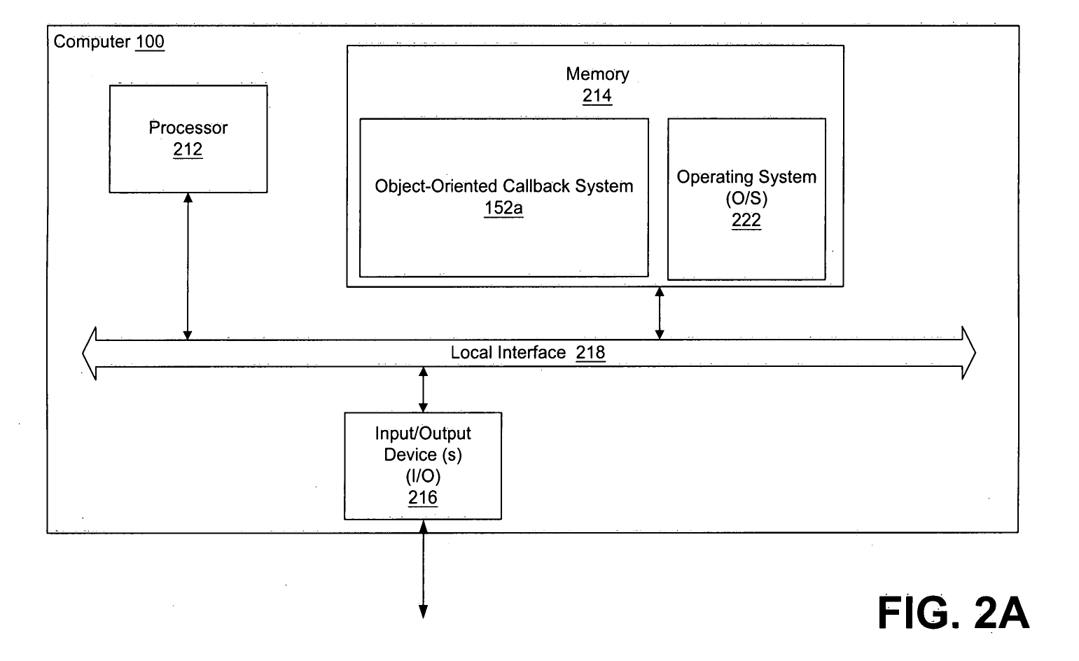

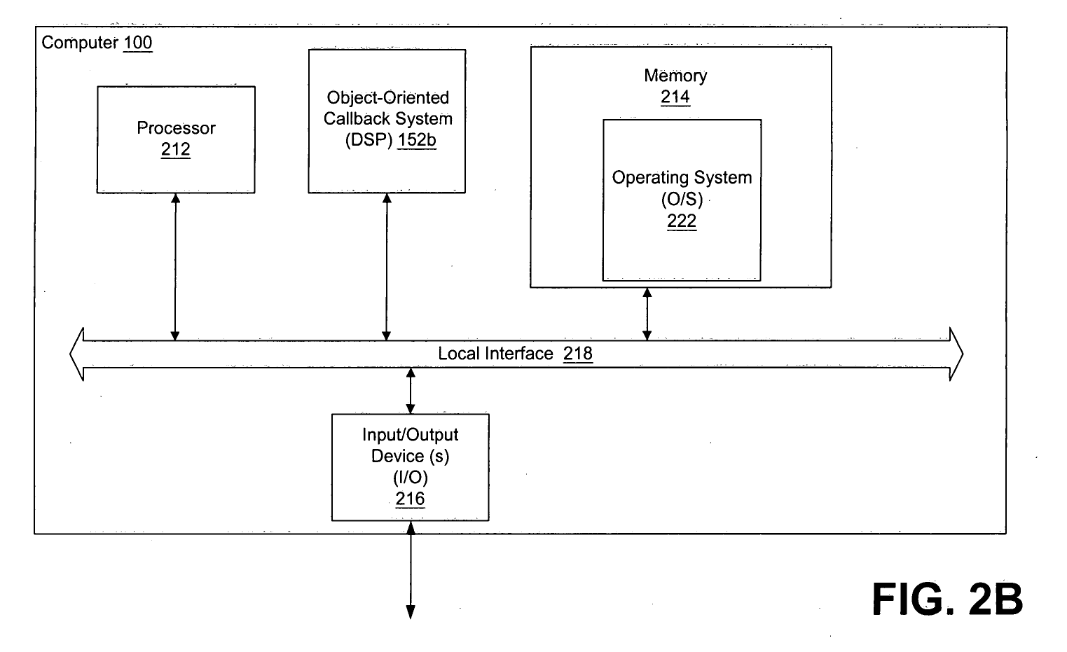

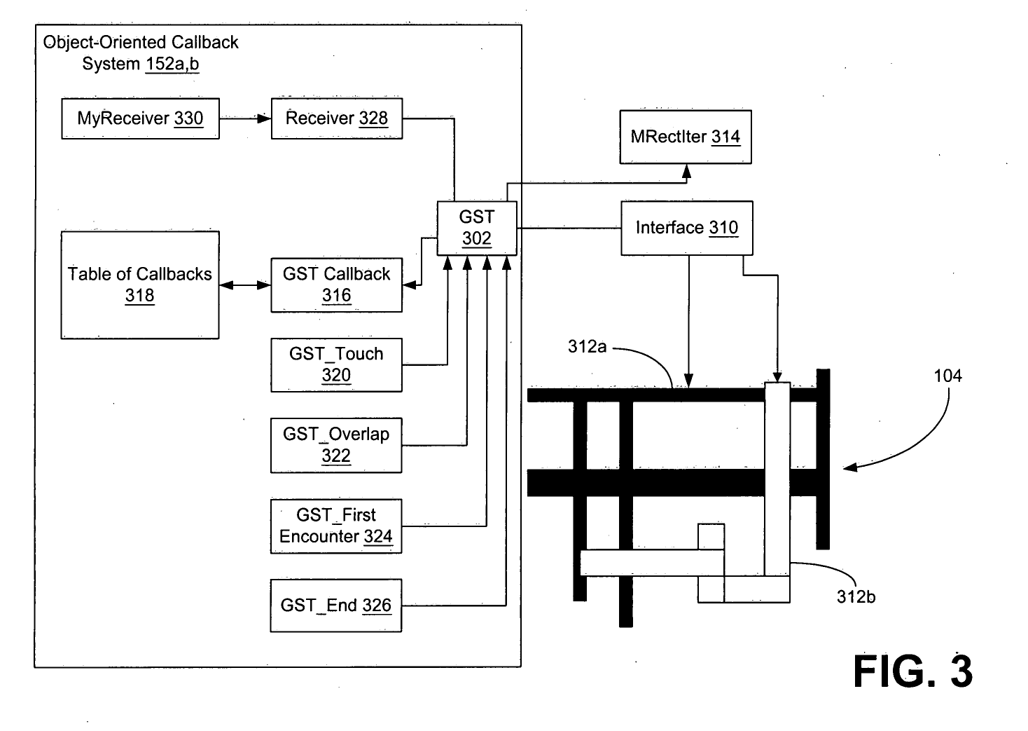

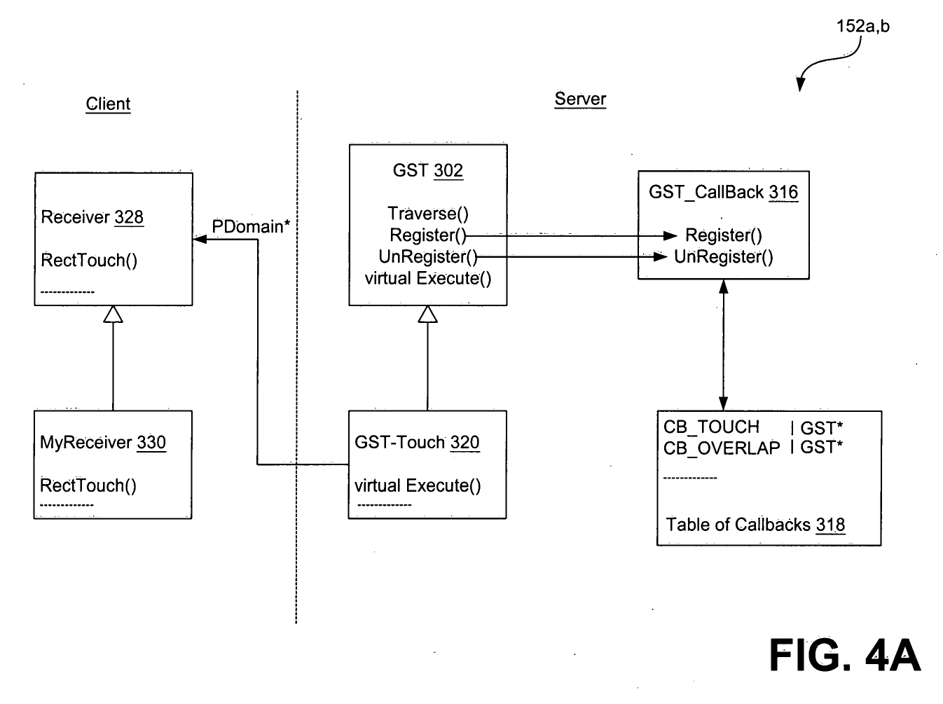

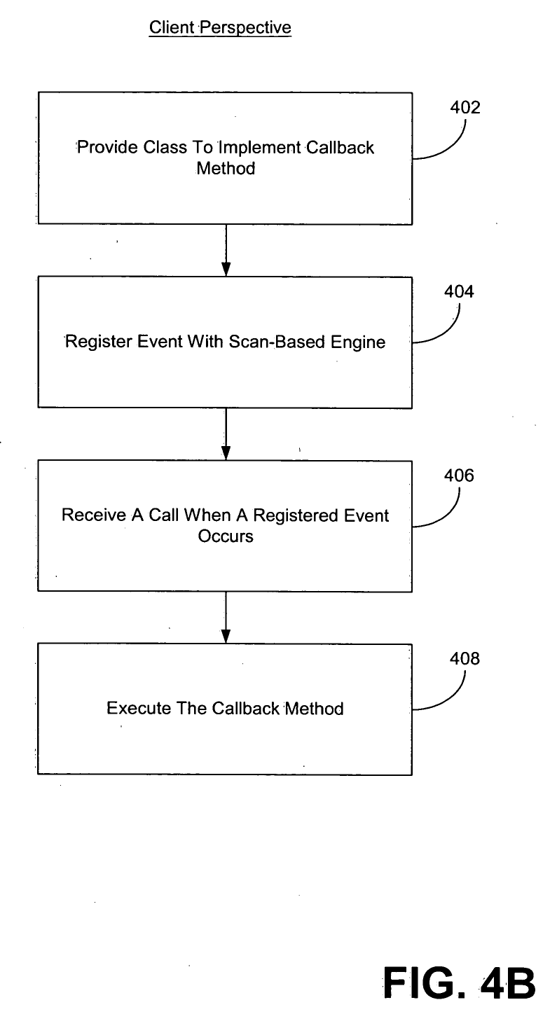

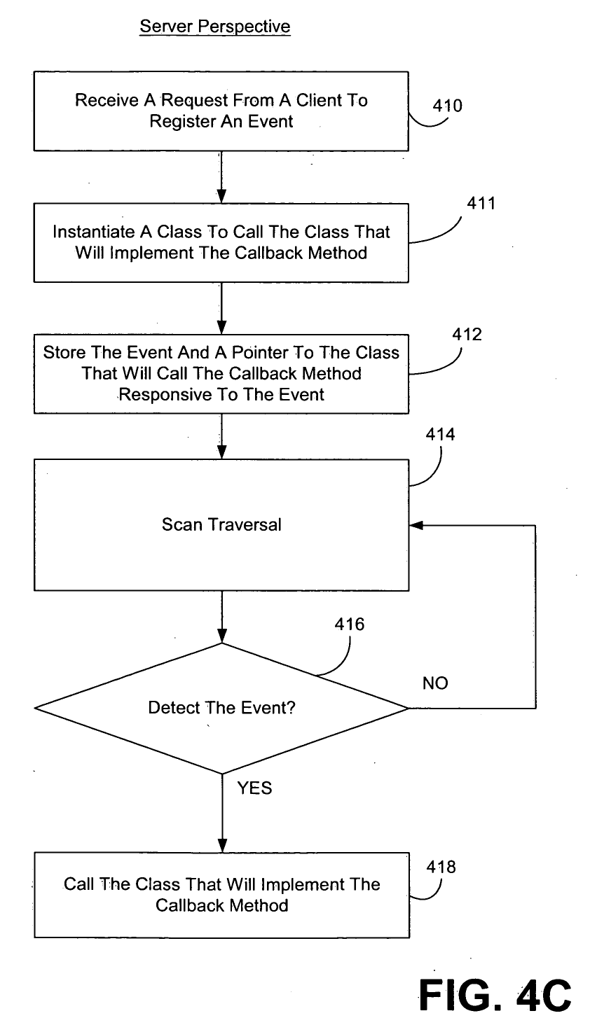

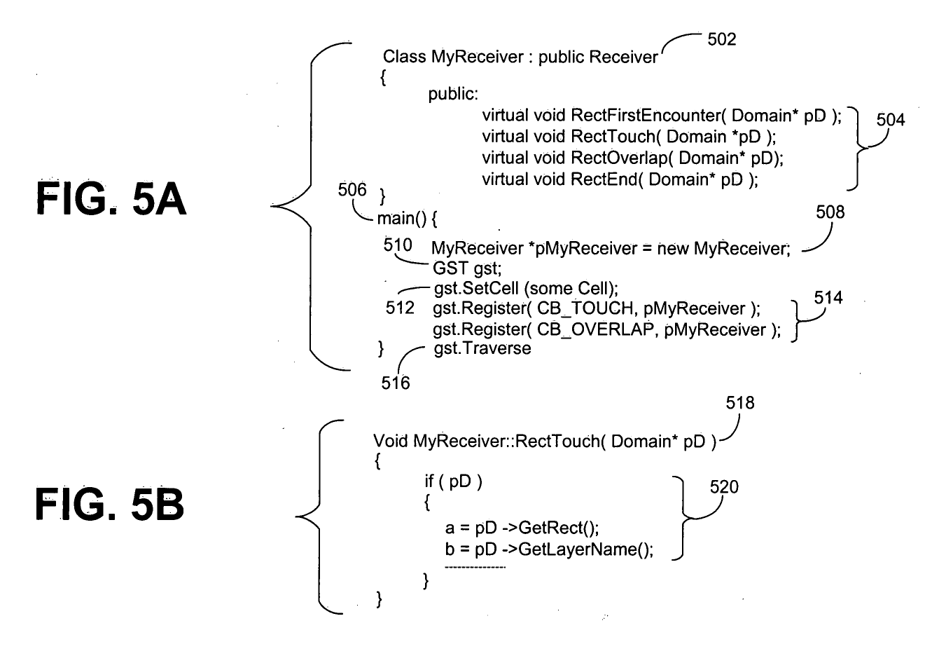

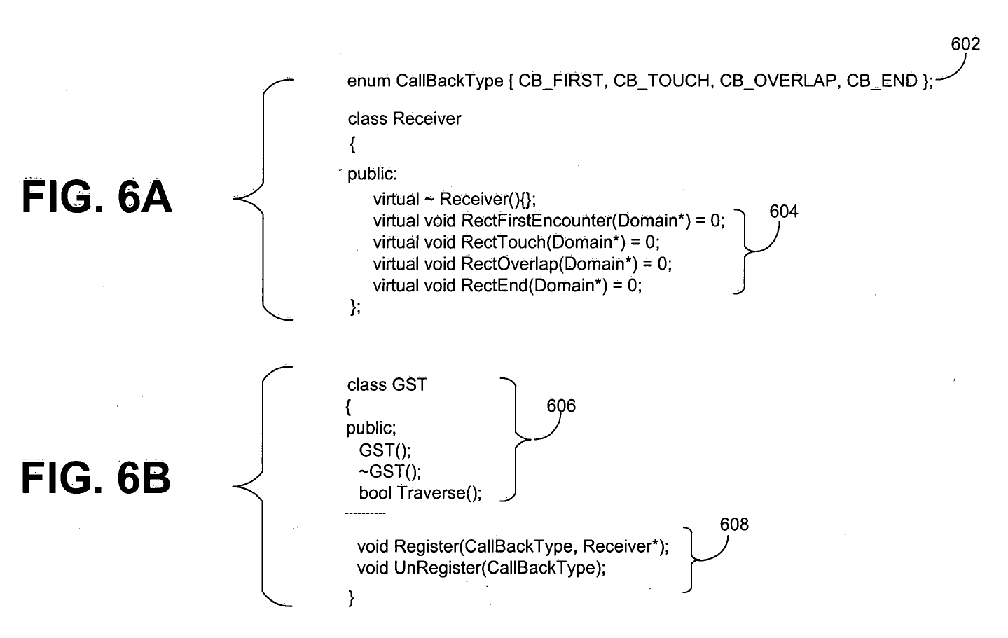

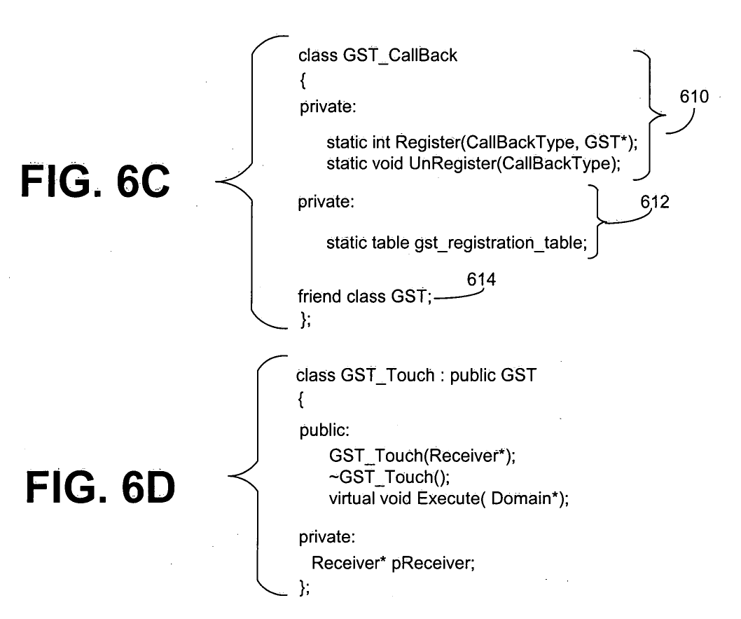

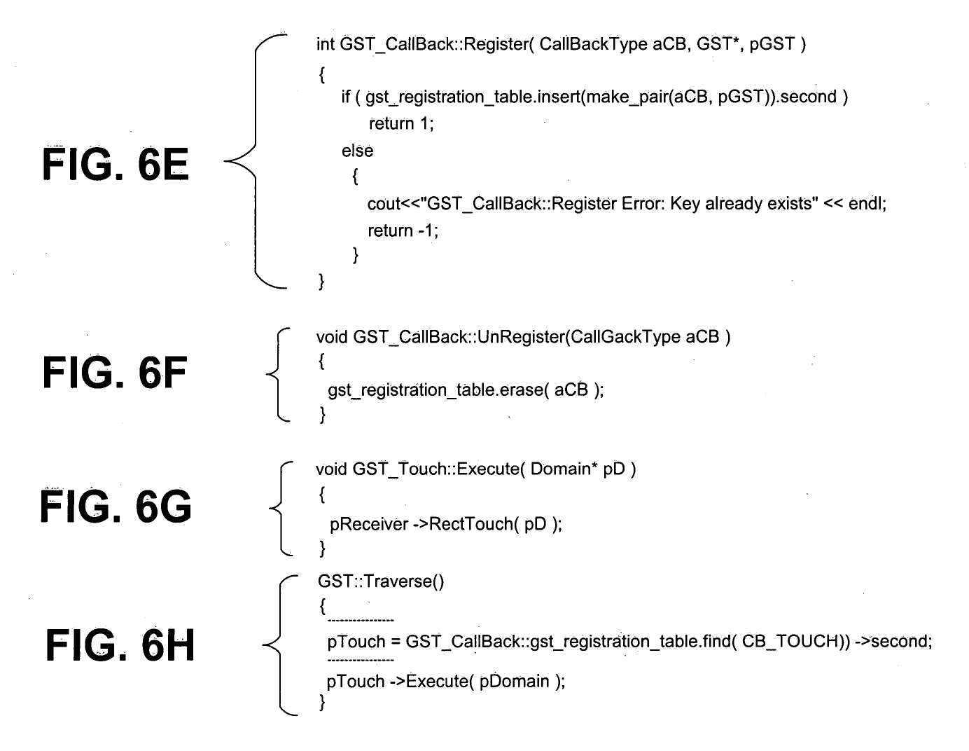

In the description that follows, an example general purpose computer is described in FIG. 1 as one implementation, among many, of an object-oriented callback system, followed by a description of different embodiments of an object-oriented callback system in FIGS. 2A-2B. FIG. 3 will be used to illustrate modules of an object-oriented callback system and their cooperation in a scan traversal embodiment, and an example illustrating methodology implemented by the object-oriented callback system shown in FIG. 3 is illustrated with a schematic diagram and flow diagrams in FIGS. 4A-4C. Finally, example pseudo code for the object-oriented callback system shown in FIG. 3 will be demonstrated in FIGS. 5 (client application perspective) and 6 (server perspective). Various object-oriented methods are described in FIGS. 6-9.

FIG. 1 is a schematic diagram that depicts a general purpose computer 100 that serves as an example implementation for an object-oriented callback system, the latter represented with reference numeral 152. The general purpose computer 100 can be in a stand-alone configuration, or networked among other computers. The general purpose computer 100 includes a display terminal 102 that provides a display of a physical layout 104 for a semiconductor chip, such as a VLSI chip. At this stage of the design process, circuits have been converted to the physical layout 104, which is now ready for additional testing and/or event detection before preparing masks. Although the physical layout 104 is shown on the display terminal 102, suggesting user-interaction in the implementation of the object-oriented callback system 152, it would be understood by those having ordinary skill in the art that some embodiments of the object-oriented callback system can be implemented in a manner that is transparent, in whole or in part, to the user. The physical layout 104 shown on the display terminal 102 can be displayed in a variety of perspectives as is true generally for computer-aided design displays. The physical layout 104 of this example is displayed as a top-plan view, with the clear rectangles representing a first layer of objects (e.g., circuit elements such as transistors, resistors, interconnections, etc.) and the black rectangles representing a second layer of objects disposed beneath the first layer. Fewer or more layers and/or rectangles are possible, as would be understood by those having ordinary skill in the art.

The object-oriented callback system 152 can be implemented in software (e.g., firmware), hardware, or a combination thereof. In the currently contemplated best mode, the object-oriented callback system 152 is implemented in software, as an executable program, and is executed by the general purpose computer 100 or other special or general purpose digital computer, such as a personal computer (PC; IBM-compatible, Apple-compatible, or otherwise), workstation, minicomputer, or mainframe computer.

FIG. 2A is a block diagram showing a configuration of the general purpose computer 100 that can implement the object-oriented callback system. In FIG. 2A, the object-oriented callback system is denoted by reference numeral 152a. Generally, in terms of hardware architecture, the computer 100 includes a processor 212, memory 214, and one or more input and/or output (I/O) devices 216 (or peripherals) that are communicatively coupled via a local interface 218. The local interface 218 can be, for example but not limited to, one or more buses or other wired or wireless connections, as is known in the art. The local interface 218 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 212 is a hardware device for executing software, particularly that which is stored in memory 214. The processor 212 can be any custom made or commercially available processor, a central processing unit (CPU), an auxiliary processor among several processors associated with the computer 100, a semiconductor-based microprocessor (in the form of a microchip or chip set), a macroprocessor, or generally any device for executing software instructions.

The memory 214 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 214 may incorporate electronic, magnetic, optical, and/or other types of storage media. Note that the memory 214 can have a distributed architecture, where various components are situated remote from one another, but can be accessed by the processor 212.

The software in memory 214 may include one or more separate programs, each of which comprises an ordered listing of executable instructions for implementing logical functions. In the example of FIG. 2A, the software in the memory 214 includes the object-oriented callback system 152a and a suitable operating system (O/S) 222. The operating system 222 essentially controls the execution of other computer programs, such as the object-oriented callback system 152a, and provides scheduling, input-output control, file and data management, memory management, and communication control and related services.

The object-oriented callback system 152a is a source program, executable program (object code), script, or any other entity comprising a set of instructions to be performed. The object-oriented callback system 152a can be implemented, in one embodiment, as a distributed network of modules, where one or more of the modules can be accessed by one or more applications or programs or components thereof. In other embodiments, the object-oriented callback system 152a can be implemented as a single module with all of the functionality of the aforementioned modules. When a source program, then the program is translated via a compiler, assembler, interpreter, or the like, which may or may not be included within the memory 214, so as to operate properly in connection with the O/S 222. In the currently contemplated best mode, the object-oriented callback system 152a is software.

The I/O devices 216 may include input devices, for example but not limited to, a keyboard, mouse, scanner, microphone, etc. Furthermore, the 1/0 devices 216 may also include output devices, for example but not limited to, a printer, display, etc. Finally, the I/O devices 216 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When the computer 100 is in operation, the processor 212 is configured to execute software stored within the memory 214, to communicate data to and from the memory 214, and to generally control operations of the computer 100 pursuant to the software. The object-oriented callback system 152a and the O/S 222, in whole or in part, but typically the latter, are read by the processor 212, perhaps buffered within the processor 212, and then executed.

When the object-oriented callback system 152a is implemented in software, as is shown in FIG. 2A, it should be noted that the object-oriented callback system 152a can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The object-oriented callback system 152a can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In an alternative embodiment, where the object-oriented callback system 152a is implemented in hardware, the object-oriented callback system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc., or can be implemented with other technologies now known or later developed.

FIG. 2B is a block diagram of another embodiment wherein the functionality of the object-oriented callback system is implemented in a digital signal processor 152b. Like components to those shown in FIG. 2A are shown and therefore description of the same are omitted for brevity.

FIG. 3 provides a decomposition of the modules and/or data structures of the object-oriented callback system 152a,b that receives and reports on event information during a scan traversal of a physical layout. Each labeled rectangle in FIG. 3 represents a “class” in object-orientated terminology, or a “data structure” in traditional procedural languages. In the context of object-oriented terminology, each class can be implemented as a separate module that can each be used by other application programs, or combined into a single application program. As shown, FIG. 3 includes a traversal or scan-traversal engine class labeled GST 302. In communication with the GST class 302 is a Receiver class 328, MRectIter class 314, and an interface class 310. The interface class 310 couples the scan traversal mechanisms of the GST class 302 to the physical layout 104.

The physical layout 104 includes a plurality of objects such as rectangle 312a disposed in a first layer and rectangle 312b disposed in a second layer (the black or colored rectangles represents a layer of rectangles that are disposed beneath the rectangles that are clear or non-colored). The MRectIter class 314 is a multiple rectangle iterator class. The MRectlter class 314 manages a scan line traversal for every metal layer that the scanning algorithm of the GST class 302 is processing. Thus, the GST class 302, the interface class 310, and the MRectlter class 314 are primarily responsible for the scanning mechanisms. Further information on scanning methods can be found in the utility application filed on the same date and referred to in the cross-reference section of this utility application.

The callback mechanisms of certain embodiments are handled by the Receiver class 328 and the MyReceiver class 330, in cooperation with the GST class 302, GST_Callback class 316, GST_Touch class 320, GST_Overlap class 322, GST_First Encounter class 324, GST_End class 326, and a table of callbacks class 318. The Receiver class 328 is an abstract receiver class that includes a virtual method. The MyReceiver class 330 is a concrete receiver class, as the term “concrete” is known in the art, within which a client application interested in processing specified events, such as connectivity events, implements the callback methods or APIs. An abstract class, as that term is recognized and well-known to object-oriented programmers, exists as a “parent” (e.g., Receiver class 328) to derived classes (e.g., MyReceiver class 330) that will be used to instantiate objects. The GST_Touch class 320, GST_First Encounter class 324, GST_End class 326, and GST_Overlap class 322 inherit the properties of the GST class 302 and implement a virtual method to execute the appropriate callback when an event occurs. All of these classes have an ISA (“is a”, or inheritable) relationship with the GST class 302 enabling classes to be stored generically with the table of callbacks class 318, thus taking advantage of polymorphism. The GST_Callback class 316 registers events with the table of callbacks class 318. When a registered event is detected, the appropriate callback method for reporting the event is implemented by the MyReceiver class 330.

In general, rather than registering a simple callback pointer, a client application defines one or more classes that implement the callback methods of the object-oriented callback system. The client application can then register with the GST class 302 or other servers or scan traversal-based engines, which of the events of the scanned based traversal it is interested in. As the GST class 302 performs its scanned-based traversals via the interface class 310, it can check which events the client application is registered for, and make the appropriate call. More particularly, the GST_Touch class 320 uses its “Execute method” (e.g., Execute API( )) to call the “callback” method in the MyReceiver class 330. The GST_Touch class 320 “ISA” GST class. The GST_Touch class 320 thus inherits the “Execute method” from the GST class 302. In fact, each of the GST classes (e.g., 320, 322, 324, and 326) inherit from the GST class 302, and thus can implement a virtual Execute API( ) according to well-known methodologies.

As indicated above, it is this Execute API( ) that calls the correct method in the MyReceiver class 330. If a client application chooses to register for a defined event, it implements the method in the MyReceiver class 330 and registers via a Register API( ) with the GST class 302, according to well-known methodologies. Upon registration, the traversal engine, GST class 302, instantiates a GST class (or classes) and stores its pointer in a static callback table, such as the table of callbacks class 318. In other words, it is the GST class or classes stored in the table of callbacks class 318 that know how to call the MyReceiver class 330 when an event occurs. The ISA relationship between this class and/or other classes and the main GST class 302 insures polymorphic behavior when retrieving the pointers to the callbacks.

FIG. 4A is a schematic diagram that is used in cooperation with FIGS. 4B-4C to provide an example illustration of a callback implementation according to an embodiment of the invention. The diagram is split into a client side (e.g., a client application providing reporting functionality) on the left-hand side and a server side (e.g., a traversal engine such as the GST class 302) on the right-hand side, the boundary represented by a vertical dashed line. On the client side, the classes shown include client classes of the Receiver class 328 and the MyReceiver class 330. On the server side, the classes include the server classes, which include the GST class 302, the GST_Callback class 316, the table of callbacks class 318, and instantiated classes such as the GST_Touch class 320.

On the client side, the Receiver class 328 provides a method, or API, that reports on the detection of two or more rectangles of a physical layout that touch each other. The method, represented as RectTouch( ), has a default implementation in the Receiver class 328, and a specialized method is implemented by the client application in the MyReceiver class 330. Anything that is provided and implemented by the Receiver class 328 is the default behavior, unless the client application wishes to override it in the MyReceiver class 330. The overriding method provided by the MyReceiver class 330 may even be much less sophisticated that the default behavior provided by the Receiver class 328.

In other words, the MyReceiver class 330 inherits the virtual method, RectTouch( ), from the Receiver 328, but the MyReceiver class 330 implements the RectTouch( ) method in a manner as desired by the client application. The client application “decides” which event to register for. When it does register for an event, the client application can either provide a default method (e.g., provide a print statement that reports on the event) via the Receiver class 328, or the client application can customize the default method via the MyReceiver class 330, such as gathering statistical information via the information passed to it, in addition to or in lieu of providing a print out.

Note that there is an “open” or non-colored arrowhead with a “tail” originating at the MyReceiver class 330 and the arrowhead located adjacent to the Receiver class 328, in addition to a similar arrow shown disposed between the GST_Touch class 330 and the GST class 302. The open arrowhead suggests inheritance, such that the class at the opposite end of the arrowhead (e.g., MyReceiver class 330) inherits the base-functionality of the class to which the arrowhead is pointing (e.g., Receiver class 328), in addition to optionally having more specialized functionality for that particular method. For example, upon the detection of a rectangle touching another rectangle in the physical layout 104 (FIG. 3), the Receiver class 328 may implement an “event-alert” method, such as printing out a record of the event that was detected. The MyReceiver class 330 can implement another “event-alert” method inherited from the Receiver class 328, such as alerting a designer through a graphical user interface of the detected event, thus overriding the “event-alert” method of printing out a record as implemented in the Receiver class 328.

On the server side, the GST class 302 provides for several methods or APIs, including a traversal method (represented as Traverse( )), registration of events that the application has requested notification of (represented as Register( )), and the removal from a registration table of callbacks (represented as UnRegister( )). The GST class 302 also includes a virtual Execute method or API, which is used by the GST class 302 to call the method (e.g., callback) corresponding to the registered event. The GST class 302 makes this call through the GST_Touch class 320, which inherits the functionality of the GST class 302 to perform the actual callback for the GST class 302. The GST_Callback class 316 is a class that registers (and unregisters) the callbacks from the GST class 302 to the table of callbacks class 318. The table of callbacks class 318 includes the identifiers of events of touching rectangles (e.g., via CB_TOUCH) and/or other identifiers of events such as overlapping rectangles (e.g., CB_OVERLAP). The table of callbacks class 318 also includes a pointer to the class that is to be notified when the event occurs. For example, the pointer to the class that calls the execute method corresponding to the event identifier CB_TOUCH is the pointer (GST*) to the GST_Touch class 320. The execute method of the GST_Touch class 320 in turn calls the appropriate method in the MyReceiver class 330.

For an analysis of operation of the object-oriented system 152a,b, refer to FIG. 4B with continued reference to FIG. 4A. Step 402 includes a client application providing a class to implement a desired callback method. In this example, the MyReceiver class 330 is created to implement a RectTouch( ) method when rectangles are detected by the scanning mechanisms of the GST class 302. Step 404 includes the client application registering the event of interest (e.g., rectangles touching) with the GST class 302. In registering the event of interest, the client application also includes a pointer that indicates the class that is to be informed of this event and is to also implement this method (i.e., the MyReceiver class 330). In other words, the client application passes a pointer to the MyReceiver class 330 when it registers. This pointer is also passed to the GST class 302. The GST class 302 also notices that in addition to the pointer to the MyReceiver class 330, the client application specifies the type of event (e.g., rectangles touching as represented by event identification GST_TOUCH). Based on this, the GST class 302 creates an instance of the GST_Touch class 320 (which now knows about the MyReceiver class 330) and stores a pointer to this class (320) in the table of callbacks class 318.

Once registered and the server has taken the appropriate measures (as explained in association with FIG. 4C), the detection of an event by the GST class 302 responsively results in a call from the GST_Touch class 302 (step 406) to the application (or more specifically, to the Receiver class 328 (and thus the MyReceiver class 328)). More specifically, the call is actually implemented by the GST_Touch class 320, which inherits the functionality of the GST class 302, as represented by the open arrowhead on the connecting line between the GST class 302 and the GST_Touch class 320. The GST_Touch class 320, as part of its call to the client application, includes information about the rectangles touching (e.g., what layer, which rectangles, etc.) via the pointer (represented as PDomain* on the connecting line between the GST_Touch class 320 and the Receiver class 328). Responsive to receiving the call from the GST_Touch class 320, the MyReceiver class 330 implements the RectTouch( ) method (step 408). Such a method can include whatever the client application has configured the method to be, such as alerting a user through a user interface barker, among other methods.

Refer to FIG. 4C for the server perspective, with continued reference to FIG. 4A. Step 410 includes receiving a request from a client application to register an event. The server, in this example, is represented using the GST class 302. The GST class 302 receives the request to register an event and responsively instantiates a GST class (e.g., GST Touch class 320) that will actually call the class that is to implement the callback method (step 411). The GST class 302 also stores the event (e.g., identified by CB_TOUCH) and a pointer (GST*) to the class that will call the method (GST_Touch class 320) corresponding to the event (step 412). The GST class 302 performs this step by passing the pointer and the event, via a Register( ) method or API, to the GST_Callback class 316. The GST_Callback class 316 in turn registers the pointer and event with the table of callbacks class 318. This event is stored as a callback, represented by identifier CB_TOUCH. The pointer is represented as GST*.

When executing a scan traversal in step 414, the GST class 302 determines whether an event (e.g., two rectangles touching in a physical layout) is detected (step 416). The event or events are detected by the Traverse( ) method of the GST class 302. If none are detected, the scan traversal continues without a callback. If an event is detected, the GST class 302 queries the table of callbacks 318, which indicates a pointer stored there previously for a touch-callback (e.g., CB_TOUCH|GST*). This callback suggest that there is a client application that seeks to have a defined method in a class called each time a touch is encountered. Thus, the GST class 302 calls the class (MyReceiver 330) referenced by the pointer (GST*) via the GST_Touch 320 executing a virtual Execute( ) method (Step 418). As part of this Execute( ) method, the PDomain* is passed, which includes information about the detected event and objects associated with detected event. This passing of information provides for an information-rich API that can be used for further processing.

Any process descriptions or blocks in flow diagrams should be understood as representing modules, segments, or portions of code which include one or more executable instructions for implementing specific logical functions, methods, and/or steps in the process, and alternate implementations are included within the scope of the preferred embodiment of the present invention in which steps may be executed out of order from that shown or discussed, including substantially concurrently or in reverse order, depending on the functionality involved, as would be understood by those reasonably skilled in the art of the present invention.

FIGS. 5A-6H provide example pseudo code for the methodology of the object-oriented callback system 152a,b illustrated in FIGS. 3-4C. Much of the pseudo code shown in these figures provide functionality that would be understood in the context of this disclosure by one having ordinary skill in the art, and thus only certain portions of the pseudo code are elaborated-on to provide further insight. FIGS. 5A-5B illustrate the example pseudo code from the client application perspective. As described above, a Receiver class is one that actually implements the callback methods or APIs that the server engine, for example, the GST class 302 (FIG. 3), calls. Thus the pseudo code shown in FIG. 5A defines and implements the Receiver class. The Receiver class describes which methods are to be implemented by a client application. Referring to FIG. 5A, reference line 502 declares the class MyReceiver, and makes this class public. The pseudo code at reference line 504 declares four methods or APIs that will take as arguments a pointer of the domain class (e.g., PDomain* as shown in FIG. 4A). The methods are declared virtual. The virtual methods at reference line 504 include RectFirstEncounter, RectTouch, RectOverlap, and RectEnd. The RectFirstEncounter defines a method for the detection of the first rectangle that is encountered in the physical layout. The RectTouch defines a method corresponding to when rectangles touch in a physical layout. The RectOverlap defines a method corresponding to an event where rectangles overlap. Touching refers to the fact that at least two rectangles share a coordinate. Overlapping refers to the fact that at least two rectangles share an overlapping area. While touching or overlapping imply a short circuit, overlapping alone (depending on how much overlap) may increase such attributes as capacitance or inductance levels. The RectEnd defines a method corresponding to when the end of a rectangle is encountered.

A main function for the creation of the MyReceiver class is implemented starting at reference line 506. Reference line 508 instantiates a pointer to the MyReceiver class. Reference line 510 instantiates the GST engine class. In reference line 512, the cell/artwork over which the GST engine will operate is set. In the pseudo code referenced by reference line 514, the events are registered. The callbacks for the registered events in this example are represented with CB_TOUCH, and CB_OVERLAP. Reference line 516 corresponds to the call by the client application to the GST engine to start the scan traversal of the physical layout of a chip.

FIG. 5B provides an example of one of the callback methods, RectTouch. The pseudo code at reference line 518 corresponds to the declaration of this callback method, RectTouch. The parameter pD of type Domain includes the information of the Domain object (e.g., rectangle in the physical layout) that is touching another rectangle (e.g., an object involved in the registered event). A Domain object includes the information of a given rectangle. The portion of the pseudo code represented by reference line 520 collects information about the detection of the scanned objects. For example, the GetRect( ) method extracts information, such as rectangle coordinates, corresponding to the scanned rectangle. The GetLayerName( )method provides the layer name corresponding to the touching rectangle(s).

FIGS. 6A-6H illustrate example pseudo code from a server (e.g., GST engine class) perspective. In particular, FIGS. 6A-6D provide for the relevant class definitions and FIGS. 6E-6H provide for example implementation mechanisms of the preferred embodiments. In general, a client application defines its Receiver classes. Each API for which the client application registers should be implemented, otherwise a warning is emitted from the default implementation of the Receiver class. Referring to reference line 602, the callback types are defined. The callback types are represented by identifiers CB_FIRST, CB_TOUCH, CB_OVERLAP, and CB_END. Referring to the pseudo code referenced by reference line 604, the Receiver class is defined and its elements are made public. The Receiver class is a fully abstract class. The in/out parameter of type Domain is used to pass information back and forth between the application and the GST engine class. As shown, the class Receiver includes RectFirstEncounter, RectTouch, RectOverlap, and RectEnd methods.

Referring to FIG. 6B, the pseudo code referenced by reference line 606 defines the GST class. The GST class includes the traverse method. Reference line 608 also indicates other methods of the GST class, including a register method and an unregister method. As shown, the arguments taken by these latter methods include the callback type and the pointer to the Receiver class (e.g., MyReceiver) requesting notification of an event.

FIG. 6C illustrates pseudo code that defines the GST_CallBack class. As described above, the GST_Callback class registers callbacks in a table of callbacks class 318 (FIG. 3). The pseudo code referenced by reference line 610 corresponds to the definition of the callbacks corresponding to the registered events. The pseudo code represented by reference line 612 provides for the declaration of a STL (Standard Template Library) table to hold registered event.(s) Reference line 614 defines the GST class as a friend class, referring to the fact that it (GST) has access to information corresponding to the GST_Callback class despite the fact that the callbacks are declared private.

FIG. 6D corresponds to the pseudo code for defining the class GST_Touch, which actually implements the callback to the Receiver class implementing a method responsive to a detected, registered event.

FIGS. 6E-6H provide for the relevant implementation on the server side for the object callback system 152a,b (FIG. 3). Referring to FIG. 6E, the GST callback class implementation manages the STL map of callback pointers. The pseudo code of FIG. 6E prevents re-registering an event that is already registered. The pseudo code shown in FIG. 6F unregisters (e.g., erases) an event from the table. FIG. 6G corresponds to pseudo code for the function that actually calls the client's implementation of the touch event. In other words, the pseudo code calls the RectTouch method implemented in the MyReceiver class. FIG. 6H corresponds to the pseudo code for the traversal mechanism of GST engine. As the physical layout is scan-traversed, a check is made to determine if a CB_TOUCH event was registered and if so, the pointer is saved in pTouch. If a “touch” occurs, pTouch is used to execute the code implemented by the client application in the MyReceiver class.

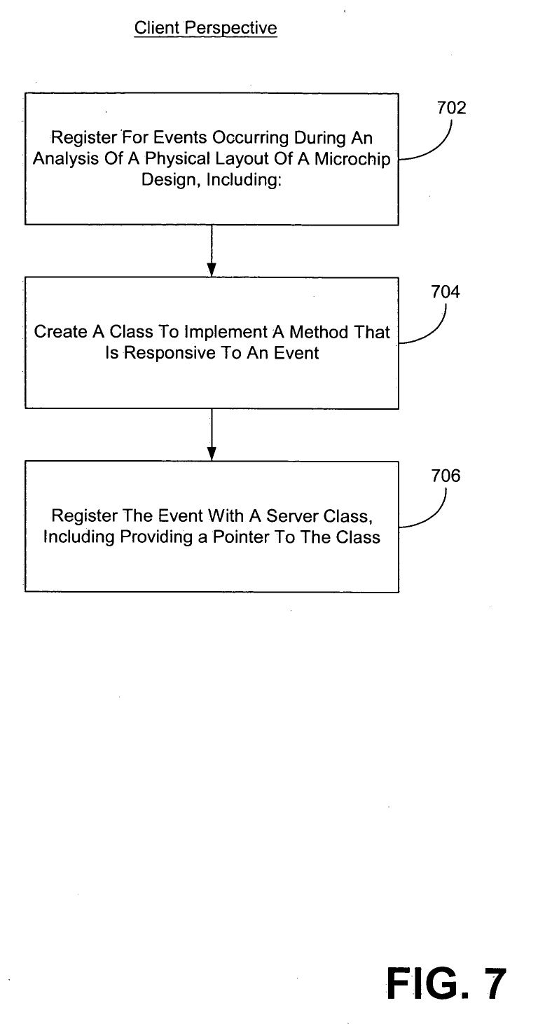

In view of the above description it will be appreciated that one embodiment of an object oriented method for a client application may comprise, as illustrated in FIG. 7, registering for events occurring during an analysis of a physical layout of a microchip design (step 702), including creating a class to implement a method that is responsive to an event (step 704), and registering the event with a server class, wherein the registering includes providing a pointer to the class (step 706).

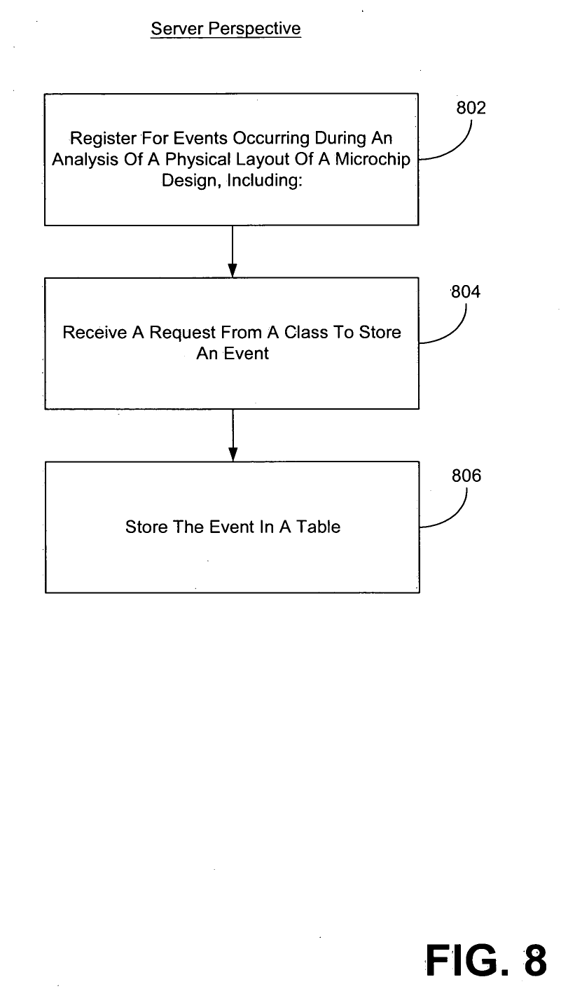

FIG. 8 provides another embodiment of an object oriented method for a server class, comprising registering for events occurring during an analysis of a physical layout of a microchip design (step 802), including receiving a request from a class to store an event (step 804), and storing the event in a table (step 806).

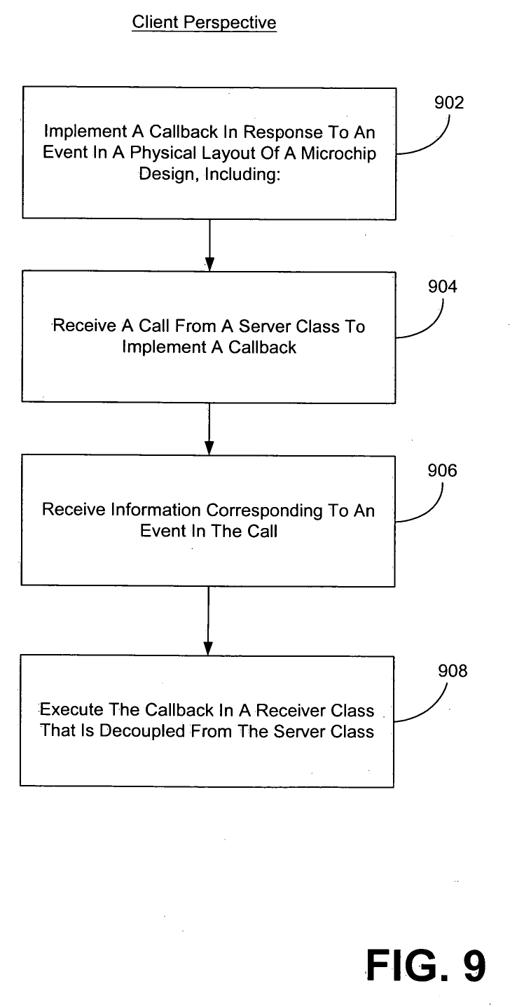

Another embodiment may comprise an object-oriented method for a client application, as illustrated in FIG. 9, comprising implementing a callback in response to an event in a physical layout of a microchip design (step 902), including receiving a call from a server class to implement a callback (step 904), receiving information corresponding to an event in the call (step 906), and executing the callback in a receiver class that is decoupled from the server class (step 908).

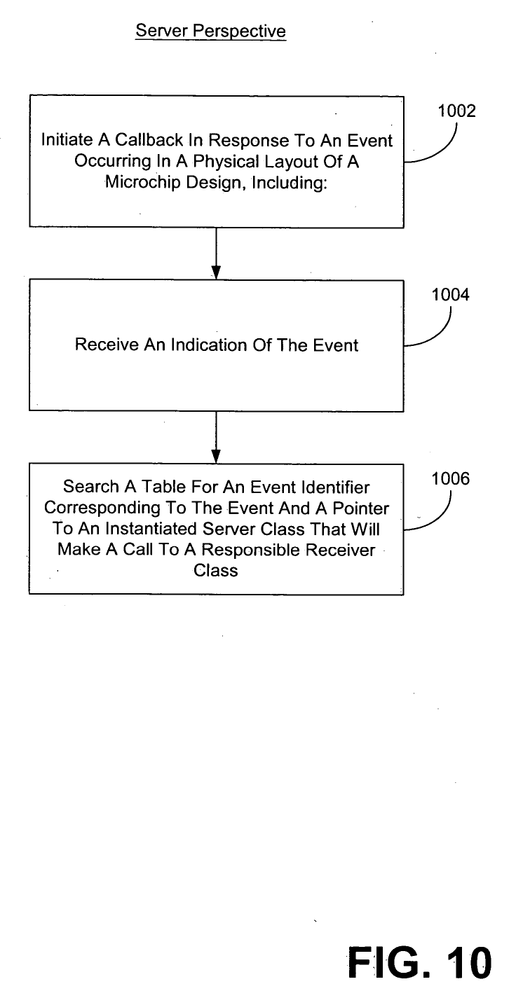

Another embodiment may comprise an object-oriented method for a server engine class, as illustrated in FIG. 10, comprising initiating a callback in response to an event occurring in a physical layout of a microchip design (step 1002), including receiving an indication of the event (step 1004), and searching a table for an event identifier corresponding to the event and a pointer to an instantiated server class that will make a call to a responsible receiver class (step 1006).

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. An object-oriented method for a client application, said method comprising:
registering for events occurring during an analysis of a physical layout of a microchip design, including:
creating a class to implement a method that is responsive to an event; and
registering the event with a server class, wherein the registering includes providing a pointer to the class.

2. The method of claim 1, wherein the creating includes creating a concrete class that inherits a virtual method of an abstract class.

3. The method of claim 2, wherein the concrete class executes a callback method.

4. The method of claim 1, wherein the registering the event includes informing the server class of at least one connectivity event between objects in a physical layout that a client application is to report on.

5. The method of claim 1, wherein the registering includes executing a register applications programming interface.

6. The method of claim 1, further including creating a new method to handle a new event while retaining the class.

7. An object-oriented method for a server class, said method comprising:
registering for events occurring during an analysis of a physical layout of a microchip design, including:
receiving a request from a class to store an event; and
storing the event in a table.

8. The method of claim 7, wherein the receiving a request includes receiving the event that the class seeks notification of upon detection.

9. The method of claim 7, wherein the storing includes storing the events in a table of callbacks class.

10. The method of claim 7, further including instantiating a server class and storing its pointer in a table of callbacks class, the server class being called responsive to the event being detected.

11. The method of claim 10, wherein the server class is configured to call a receiver class upon being called in response to the event being detected.

12. The method of claim 7, wherein the storing includes implementing an applications programming interface.

13. The method of claim 7, further including erasing the event.

14. The method of claim 13, wherein the erasing includes implementing an applications programming interface.

15. An object-oriented method for a client application, said method comprising:
implementing a callback in response to an event in a physical layout of a microchip design, including:
receiving a call from a server class to implement a callback;
receiving information corresponding to an event in the call; and
executing the callback in a receiver class that is decoupled from the server class.

16. The method of claim 15, wherein the information includes coordinate information about the objects that correspond to the event.

17. The method of claim 15, wherein the executing the callback includes executing a method that reports on a detected event.

18. The method of claim 15, wherein the method includes an applications programming interface.

19. The method of claim 15, wherein the executing the callback includes reporting events occurring in a physical layout.

20. The method of claim 19, wherein the reporting events includes at least one of reporting two rectangles touching, two rectangles overlapping, the first encounter of a rectangle, and the encounter of the end of a rectangle.

21. The method of claim 15, wherein the executing the callback includes executing a method in a concrete receiver class.

22. The method of claim 15, wherein the executing the callback includes executing a method in an abstract receiver class.

23. An object-oriented method for a server engine class, said method comprising:
initiating a callback in response to an event occurring in a physical layout of a microchip design, including:
receiving an indication of the event; and
searching a table for an event identifier corresponding to the event and a pointer to an instantiated server class that will make a call to a responsible receiver class.

24. The method of claim 23, wherein the instantiated server class is an instantiation of a server engine class.

25. The method of claim 23, further including passing information from the table about the type of event and the objects that caused the event.

26. An object-oriented callback system, comprising:
a client class configured to receive information corresponding to an event in an artwork of a microchip design, said client class configured to use the information to report on the event.

27. The system of claim 26, wherein the client class is configured to register the event with a server class, wherein the registering includes providing a pointer to the client class.

28. The system of claim 26, wherein the client class is configured to receive a call from a server class to execute an applications programming interface that corresponds to a callback method.

29. The system of claim 26, wherein the client class is decoupled from a server class, said server class configured to provide a scan traversal of the artwork.

30. The system of claim 26, wherein the client class includes an abstract receiver class and a concrete receiver class.

31. The system of claim 30, wherein the concrete receiver class executes an applications programming interface corresponding to a callback method.

32. The system of claim 26, further including a server class decoupled from the client class, said server class configured to detect events in the artwork.

33. The system of claim 32, wherein the client class and the server class are configured as a plurality of modules.

34. The system of claim 32, wherein the client class and the server class are configured as a single module.

35. The system of claim 32, wherein the client class and the server class are configured in software in cooperation with a processor.

36. The system of claim 32, wherein the client class and the server class are configured in a digital signal processor.

37. The system of claim 32, wherein the client class and the server class are embodied in a computer readable medium.

38. An object-oriented callback system, comprising:
means for creating a class to implement a method that is responsive to an event;
means for-detecting the event in artwork of a microchip design;
means for passing information about the type of event and information about objects that caused the event to occur; and
means for reporting the event.

39. A computer readable medium having a computer program comprising an object-oriented method for a client application, comprising:
logic configured to register for events occurring during an analysis of a physical layout of a microchip design, including:
logic configured to create a class to implement a method that is responsive to an event; and
logic configured to register the event with a server class, wherein the registering includes providing a pointer to the class.

40. A computer readable medium having a computer program comprising an object-oriented method for a server class, comprising:
logic configured to register for events occurring during an analysis of a physical layout of a microchip design, including:
logic configured to receive a request from a class to store an event; and
logic configured to store the event in a table.

41. A computer readable medium having a computer program comprising an object-oriented method for a client application, comprising:
logic configured to implement a callback in response to an event in a physical layout of a microchip design, including:
logic configured to receive a call from a server class to implement a callback;
logic configured to receive information corresponding to an event in the call; and
logic configured to execute the callback in a receiver class that is decoupled from the server class.

42. A computer readable medium having a computer program comprising an object-oriented method for a server class, comprising:
logic configured to initiate a callback in response to an event occurring in a physical layout of a microchip design, including:
logic configured to receive an indication of the event; and
logic configured to search a table for an event identifier corresponding to the event and a pointer to an instantiated server class that will make a call to a responsible receiver class.
